(19) United States
(12) Patent Application Publication
(10) Pub. No.: US 2003/0200127 A1
(43) Pub. Date: Oct. 23, 2003

(54) Job site problem solution systems with internet interface

(76) Inventors: Talmadge Keith McQueen, Montgomery, TX (US); Guy L. McClung III, Spring, TX (US)

Correspondence Address: Guy McClung, 16690 Champion Forest Drive, Spring, TX, 77379-7023, US

(21) Appl. No.: 10/125,077

(22) Filed: Apr. 18, 2002

(51) Int. Cl. G06F 17/60

(52) U.S. Cl. 705/7

(57) ABSTRACT

A method for producing a problem solution for an entity having a problem, the method for producing the problem solution on-site at a location at which the problem is experienced, e.g., but not limited to, on a drilling rig, the method including in at least certain aspects, the entity having the problem requesting a problem solver to address the problem, and the entity describing the problem to the problem solver, the problem solver assembling a team for solving the problem and dispatching the team on-site to the location at which the problem is experienced, the team including personnel necessary to solve the problem and to produce a presentation of a problem solution for the entity having the problem, the team gathering information related to the problem, the team on-site making a proposed solution to the problem and producing an on-site presentation of the proposed solution to the entity having the problem, the team presenting the presentation onsite to the entity having the problem, and the presentation including technical information related to the proposed solution, visual images of components of the proposed solution, and visual images of steps in an implementation of the proposed solution; and, in certain particular aspects, applying from the on-site location for protection of intellectual property related to the proposed solution.

### BACKGROUND OF THE INVENTION

1. Field of the Invention

This invention is directed to the solution of equipment and apparatus problems at a job site which may include, but is not limited to, at drilling rigs; in certain aspects to producing presentations of solutions on-site at a problem location; and in certain particular aspects to the solving of on-site problems using internet connections to access problem-solving resources off-site in real time.

2. Description of Related Art

In many instances when there is an equipment or apparatus problem at a job site, e.g. on a drilling rig, especially a job site or rig at a remote location or offshore, much time and expense are involved in: ascertaining the nature and complexity of the problem; transporting people and equipment to and from the site for study, consultations, evaluations, interviews, and testing; and dealing with decision makers who are not present at the site or at the location of the problem solvers. In many cases, problems are critical and solutions are needed in hours rather than days or weeks. Often a problem cannot be fully appreciated unless those involved in the solution go to the site. Changes in a proposed solution can further complicate the process.

There has long been a problem with an entity's need to present a solution as quickly as possible and, on the other hand to protect any new intellectual property (inventions, copyright works, trade secrets, trademarks) prior to public disclosure. The preparation and filing of correct and appropriate applications to protect intellectual property can delay any presentation; or quick disclosure can jeopardize the creating entity's rights.

There have long been needs, recognized by the present inventors, for: an efficient and effective on-site problem solution method; systems that are useful in the solution of such problems; such systems and methods which can result in solutions in a minimum of time; such systems and methods that can provide a comprehensive and clear explanation of a solution to on-site personnel and off-site engineers, designers, and decision makers; and such solutions that can include visual images for ease of understanding.

### SUMMARY OF THE PRESENT INVENTION

The present invention, in certain embodiments, provides systems and methods for solving equipment, device, apparatus, machine and system problems on a job site, e.g., but not limited to, on a drilling rig. In certain aspects, such systems and methods are for solving problems on-site at a relatively remote site or offshore, e.g., but not limited to, in the Gulf of Mexico or in the North Sea. Certain embodiments of the present invention also provide applications to protect intellectual property prior to any public disclosure or offer for sale and these embodiments effect timely filing of such applications.

In certain embodiments, methods according to the present invention include on-site personnel or their employers alerting a problem solving group (“PSG”) about the nature of a problem at a job site, e.g. on a rig. The PSG requests all available information and data on the problem (e.g., but not limited to equipment specifications, equipment run logs, drawings, surveys, photographs, manufacturers equipment brochures, etc.); reviews the data and information; optionally, researches previous solutions of similar problems; and, if necessary, requests additional data and information and/or generates such additional data and information. In certain particular aspects, all of this can be done by a PSG onsite, e.g. at a drilling rig; and in certain aspects, much if not all of this information gathering step can be done via a global communications system like the Internet or available cell phone or satellite communications system. The PSG then develops a proposed draft solution (“PSD”) and presents it to the on-site personnel and others who may be off site (e.g., but not limited to, designers, engineers, and decision makers). Such a PSD may include the following: new equipment proposal(s); drawings, photographs, videos, 3-D visual images, animation, physical model creation, physical parts creation, and/or slide presentations generated onsite or generated off-site and, in one aspect, faxed, digitally transmitted, or emailed to the site; re-design(s) of existing equipment; use of on-site equipment to solve the problem(s); and new methods involving already on-site equipment and/or off-site equipment.

In another aspect the present invention provides such methods according to the present invention which involve new engineering to be conducted on-site and/or off-site related to the PSD. Such engineering may include the design and/or machining of totally new objects, equipment and/or structures; the use of existing equipment; and/or the use of existing equipment in a new way.

The present invention, in certain aspects, provides such systems and methods that produce a final solution (“FS”) and a presentation of the final solution to the on-site personnel and/or to those off-site. For those off-site, the Internet and/or other communications systems may be used to convey the FS.

A PSG may include some or all of the following: manager(s)/supervisor(s); system designer(s); system engineer(s); surveyor(s); technician(s); scientist(s); draftsperson(s); technical writer(s); computer programmers and/or intellectual property professionals, patent agents, patent attorneys trademark attorneys, copyright attorneys and related paralegals. A PSG's equipment may include computers; wireless modem-equipped computers or other wireless communications equipment and systems; system design and drawing computer programs; 3-D image, animation, and graphics computer programs; printers; audio-visual production and/or play back equipment; photography equipment; manual drafting equipment and instruments; measurement and test equipment; and database(s) with previous solutions. In one aspect all PSG equipment is stored in and transported in a single container.

Problems that can be solved according to the present invention include, but are not limited to, the sizing of and/or selection of piping and equipment; pump selection and/or sizing; solids treatment; solids removal; equipment location; fluid flow; fluid, solids and/or equipment transportation; and fluids and solids processing.

In certain embodiments, the PSG on-site produces a detailed description solution that is input to an on-site processing system and/or that is developed using the on-site processing system. Such an on-site processing system may include one or more appropriately programmed computers, electronic devices, electronic calculators and their associated and peripheral equipment and devices. Optionally, the on-site processing system outputs information to display apparatus [e.g. screen(s), audio equipment, etc.] to display graphs, data, 2-D and or 3-D images, and/or textual description. Optionally, the on-site processing system outputs information to printer apparatus to print out text, slides; charts, drawings, graphs, and/or images. Optionally, the on-site processing system outputs information to a modeling system that produces a physical model of an object or item; and/or to a machining system that produces a part or other object whose design is part of the solution description. Such modeling systems and machining systems can be on-site and/or off-site (and, in one aspect, off-site and in communication with on-site personnel and equipment).

The on-site processing system, in at least certain embodiments, is programmed to produce applications to apply for a variety of intellectual property; including, but not limited to: applications to register a copyright in any copyright work embodying all or part of the description solution; patent applications for applying for patent protection on any invention or design developed as part of the solution description; and applications to register trademarks used in the solution description. The patent applications include both provisional and non-provisional applications, including utility, design, and plant patent applications. The trademark applications include intent-to-use applications and applications based on actual use.

Via available communication systems that made possible communication between the job site and appropriate government offices, the on-site processing system sends completed applications for filing in the selected government office or offices. In one aspect, the system confirms such filing prior to outputting information about a solution description for presentation. Any suitable available communication system may be used to effect filing of applications in government offices, including, but not limited to, phone lines, cable, wireless phone systems, and satellite phone systems. Filings may be effected by facsimile transmission or by electronic filing, e.g. but not limited to, at a government office's Internet website or email address.

Optionally or alternatively the on-site processing system may use and/or communicate with an off-site processing system that either assists in or substantially accomplishes the filing or filings of applications for intellectual property in government offices. Either on-site and/or off-site appropriate personnel may be present (and on-site as part of a PSG) to effect correct filings, including, but not limited to, draftspersons, patent agents, and/or patent attorneys. In one particular aspect the onsite processing system (with or without the assistance of an offsite processing system) effects the required intellectual property filings without the work, input, or assistance of professional personnel (e.g. patent agent, patent attorney, trademark attorney, copyright attorney).

In certain embodiments the on-site processing system produces confidentiality notices for all aspects of a presentation, e.g., but not limited to on text, drawings, screens, and slides; copyright notices for all aspects of copyright works that are part of a presentation, e.g., but not limited to on text, drawings, screens and slides; and initial confidentiality agreements that are to be executed by those present for a presentation prior to proceeding with the presentation. Alternatively an audio (and/or video version of an agreement is presented and an audio (and/or video) recording is made of the agreement of those to whom the presentation is to be made.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures.

It is, therefore, an object of at least certain preferred embodiments of the present invention to provide new, useful, unique, efficient, nonobvious systems and methods for the solution of equipment problems at job sites, including, but not limited to, on rigs;

Such systems and methods that produce on-site equipment problem solutions and which, in certain aspects, employ problem solvers on-site and/or employ a communications system like the Internet, wireless phone systems, or a satellite system to interconnect the various personnel involved in the problem solution—including those on-site and those off-site;

Such systems and methods that provide easily understandable solution presentations to on-site personnel and those off-site, which presentations may include physical models made on-site; new equipment or parts made on-site; 3-D images; videos; graphics; slides; and/or animation; and

Such systems and methods which provide confidentiality notices and/or copyright notices related to a solution presentation;

Such systems and methods which provide executable confidentiality agreements for those who will receive a presentation of a solution; and, in certain particular aspects, such systems and methods in which a confidentiality agreement is finalized and executed prior to any presentation of a solution description; and

Such systems and methods which provide, via appropriate government filings, protection of intellectual property in the solution description; and, in particular embodiments, such filing effected prior to any presentation of a solution description.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. This drawings illustrates certain preferred embodiments and are not to be used to improperly limit the scope of the invention which may have other equally effective or legally equivalent embodiments.

FIG. 1 is a schematic view of a system according to the present invention.

FIG. 2 is a schematic view of systems and methods according to the present invention.

FIGS. 3-5 are schematic views of a systems according to the present invention.

### DESCRIPTION OF EMBODIMENTS PREFERRED AT THE TIME OF FILING FOR THIS PATENT

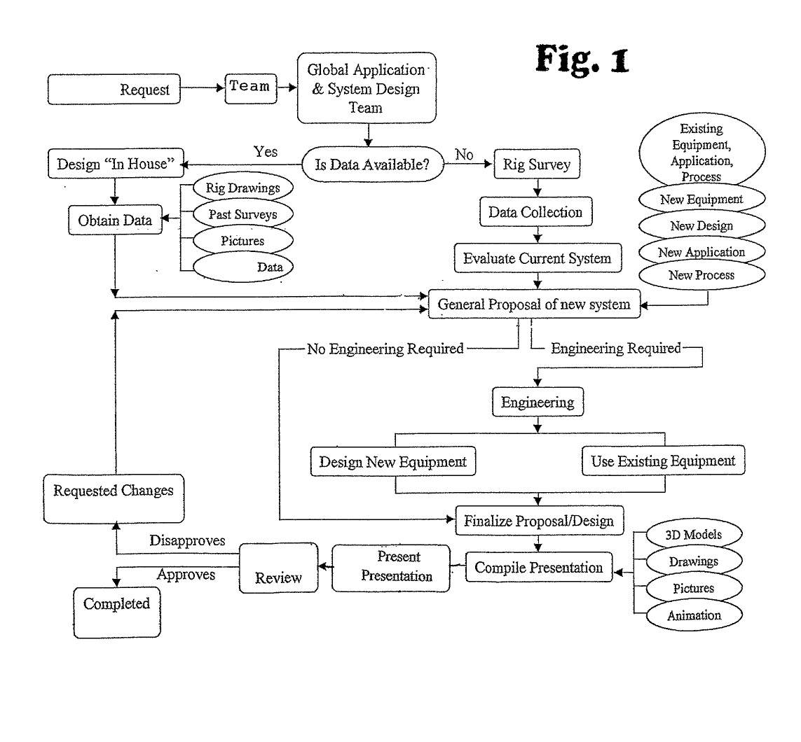

Referring now to FIG. 1, a method 10 according to the present invention begins with a request (“REQUEST”) from an entity having an equipment problem on a drilling rig. The request is made to a problem solving entity (“PSE”) which in turn conveys the request to its problem solving group (“Team”). The Team can go on-site to the rig at any time in the method and, in one aspect, goes to the rig upon notification to the PSE that there is a problem. One or more transportable containers with all the Team's equipment is made available to the Team on-site.

The Team determines whether or not there is information available related to the problem (“Is Data Available?”), e.g., but not limited to, inquiries to the entity with the problem, inquiries to others within the PSE, and searches of available databases and research sources. If no information is available (“No”) an effort is made to find and assemble information related to the problem. If information is available (“Yes”), then the Team, using the available information (“Obtain Data”), begins to develop a solution to the problem (“Design ‘In House’”). Optionally, even when information is already available (“Yes”), the Team may, according to the present invention, also pursue further information gathering (the “No” line in FIG. 1).

Available information can include existing drawings related to the particular drilling rig and/or equipment being used there (“Rig Drawings”); previous reports, surveys, studies, booklets, proposals, and/or problem solutions (“Past Surveys”); videos, photographs, etc. (“Pictures”); and/or logs, run data, performance data, specifications, etc. of the entity with the problem related to the particular drilling rig and/or particular equipment (“Data”). Once the information is analyzed, the Team produces a proposed solution to the problem (“General Proposal of New System”).

When no information is available (“No”) (of when additional information is desired), the Team does an on-site study and survey of the particular drilling rig and/or of the particular equipment related to the problem (“Rig. Survey”). This may involve discussions with rig personnel. This study and survey may include testing and measuring (“Data Collection”) related to the problem along with gathering some or all of the types of information listed under already existing (“Yes”) information—Rig Drawings; Past Surveys; Pictures; and/or Data.

Based on all the gathered information, the Team evaluates the existing equipment and the problem (“Evaluate Current System”) and develops a proposed solution (“General Proposal of New System”). This proposed solution may include a consideration of using existing things to solve the problem, e.g. existing equipment (which may be off-site or already on-site) processes, and/or methods (“Existent Equipment, Application, Process”); newly-created equipment (“New Equipment”) that can be made on-site or off-site’ new designs, e.g. designs for new equipment, new processes or new transport or treatment systems (“New Design”); new uses for existing equipment (“New Application”); and/or new processes which may use existing equipment or newly-created equipment “NewProcess”).

Then a determination is made by the Team and/or the Team onsite in conjunction with personnel of the entity having the problem whether or not the proposed solution requires new engineering work, such as, but not limited to, engineering work related to structural integrity, finite element analysis equipment modification, equipment capacity change, sound design, electrical requirements and flow requirements. If none is needed (“No Engineering Required”) the proposed solution is finalized (“Finalize Proposal/Design”) and a presentation of the finalized solution for presenting on-site and/or off-site is created (“Compile Presentation”). The presentation may include: three-dimensional physical models or items or parts (“3D Models”) made on-site or off-site, which, in one aspect, are made by available computerized laser machining apparatus, but which may also be made by any known modeling apparatus and/or machining system and/or technique; drawings of all types (“Drawings”); photographs, videos, slide presentations (“Pictures”); and/or animated presentations, e.g. of equipment operation, personnel actions, flow charts, etc. (“Animation”).

The team then presents the presentation to the entity with the problem for its study (“Review”) on-site and/or off-site.

The entity with the problem either accepts (“Approves”) the solution and enters into a transaction with the problem solver to implement the solution (“Completed”); or the proposed solution is not accepted (“Disapproves”) and requested changes (“Requested Changes”) are taken into account in developing a new solution (“General Proposal of New System”).

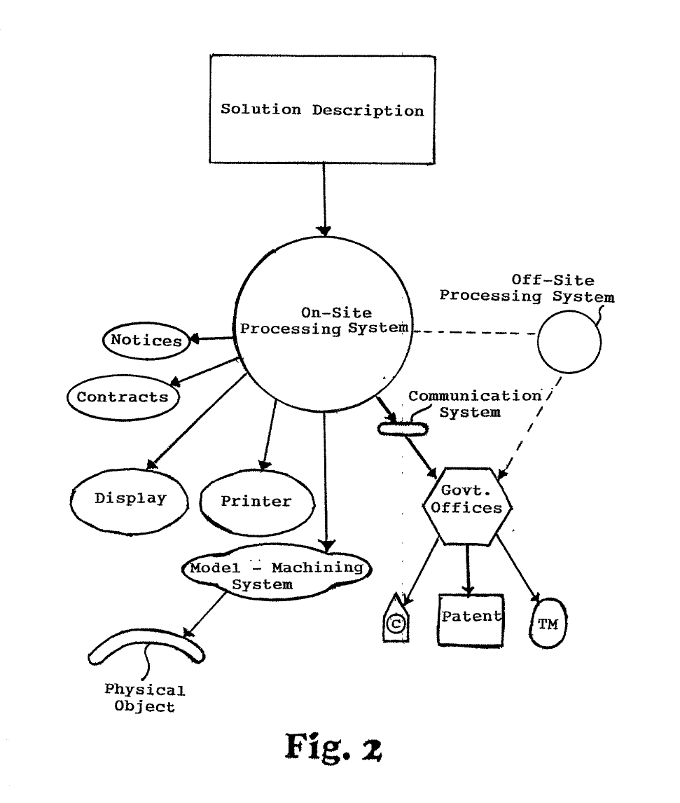

In certain embodiments of the present invention prior to the presentation of a solution description to an entity (“PRESENT PRESENTATION” box, FIG. 1), intellectual property that is part of and/or developed in the context of the solution description is protected by appropriate filings in appropriate government offices. FIG. 2 illustrates systems and methods for accomplishing this. Such filings may be effected prior to any presentation and/or they may be effected following a presentation. Optionally, appropriate confidentiality notices and/or copyright notices and/or confidentiality agreements are made part of a presentation.

A solution, “Solution Description” may include or may result in the creation of a variety of types of intellectual property, e.g. trade secrets; patentable inventions, designs, and/plants; registrable copyrights; and trademarks. In many jurisdictions rights in intellectual property can be lost forever if government filings related to them are made prior to disclosure or within a certain time of disclosure. In any jurisdictions, the entity that first files for certain intellectual property becomes its owner. Hence, in many circumstances early filing is needed to protect intellectual property rights. The systems and methods according to the present invention of FIG. 2 seek to make such protection a reality in the circumstances of problem solution according to the systems and methods of the present invention.

An appropriate computer or computers, with appropriate programming—“On-Site Processing System”—receives detailed information about the Solution Description. Those inputting the Solution Description are trained to provide the detail and information necessary to effect a variety of intellectual property filings; and fill-in-the blank pages or templates are, in certain aspects, provided to obtain the needed information. For example, for a patent application filing, the identity of inventors, drawings and written description, etc., are provided; for a trademark application filing, date of use of a mark, description of a mark, the goods or services with respect to which the mark is used, the identity of the entity using the mark, drawings of the mark, e.g.; and for copyright filings copies of textual work and/or drawings, date of creation of a work, the identity of the copyright owner, etc.

Via an appropriate communication system—“Communication System”—the On-Site Processing System conveys the completed intellectual property application(s) to the corresponding government agencies—“Govt. Offices”—including copyright offices, “©”; patent offices, “Patent”; and trademark offices, “TM.”

Optionally, the On-Site Processing System uses and is in communication with an Off-Site Processing System that assists in effecting the intellectual property filing and then communicates with the appropriate government agency to effect the filings.

In one embodiment, the On-Site Processing System is programmed to block the presentation of a solution description until receipt of a filing at a selected government agency is confirmed. Such confirmation is available from several offices by a return communication following a filing or by checking electronically or telephonically with an agency. In other aspects in which disclosure is desired prior to effecting such filings, the presentation and the filings proceed separately, with the filings done as soon as possible (and perhaps prior to or shortly after a presentation) or at a later date.

The On-Site Processing System can produce displays related to a solution description, “Display”, printed-out text, images, drawings, graphs, and descriptions, “Printer”; and/or physical objects, parts, or models—“Physical Object”—made by an on-site or off-site modeling apparatus or machining apparatus, “Model-Machining System.”

Optionally, the On-Site Processing System provides and produces confidentiality notices and/or copyright notices—“Notices”—for all or part of a solution description, including, but not limited to, such notices for drawings, graphs, data tables, text, slides, models, flow charts, production methods, process diagrams, equipment selection and/or specification, manufacturer or supplier identity, formulas, computer programs, materials selection, and/or metallurgy.

Optionally, the On-Site Processing System produces executable confidentiality agreements and/or any agreement that is to be executed by the entity receiving the presentation of a solution—“Contracts”. The On-Site Processing System may be programmed to the presentation until an agreement is executed. Execution of an agreement may be done on paper, by audio recording, and/or by video recording. Optionally, a filing to protect intellectual property may be conditioned on the execution of a confidentiality agreement and the On-Site Processing System is programmed accordingly. Alternatively, such a filing is effected and confirmation of the filing is a condition that is met prior to execution of a confidentiality agreement and the On-Site Processing System is suitably programmed to achieve this.

Any task or function described herein for the On-Site Processing System may, according to the present invention, be accomplished by any suitable and appropriately programmed computer or computers on-site and/or by any suitable and appropriately programmed computer or computers off-site in communication with those on-site.

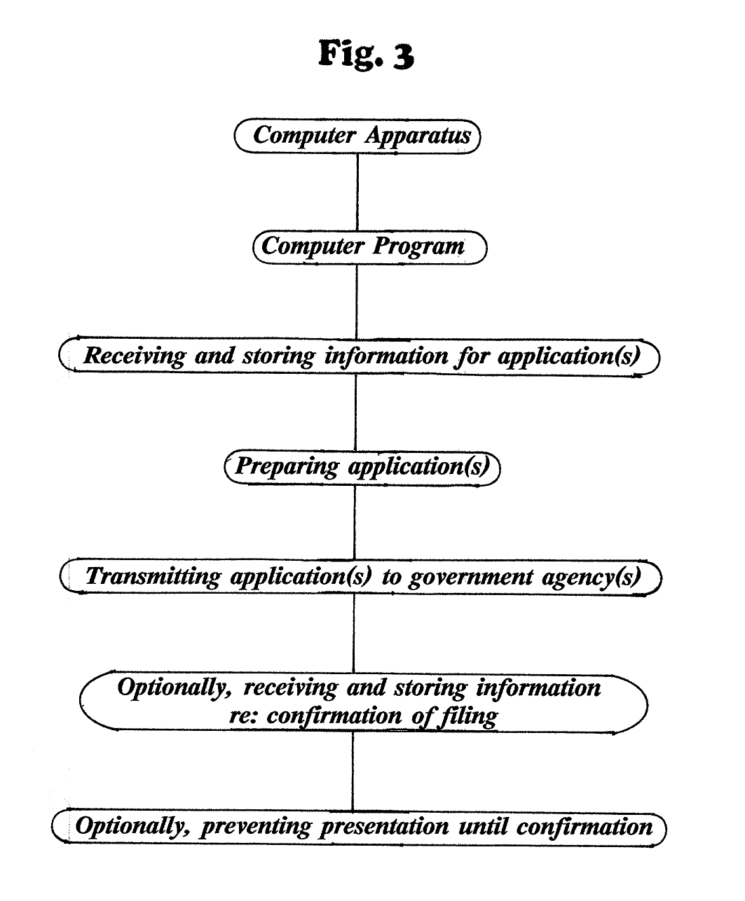

As shown schematically in FIG. 3, a computer apparatus is used according to the present invention on-site to apply for the protection of the intellectual property may be connected to a wireless communication system (e.g., cell phone, Internet and/or satellite system) for wirelessly communicating with appropriate government agencies to effect filing of one or more applications for protecting intellectual property. In certain aspects, the computer apparatus (one or two or more connected and/or networked computers) is programmed with a computer program product that includes a computer storage medium having a computer program therein for preparing and transmitting applications for protection of intellectual property, the computer program performing the steps of: receiving and storing in the computer storage medium information for preparing the application(s); preparing the applications), and transmitting at least one of the applications to at least one selected government agency for filing. Optionally, the computer program is also for performing the steps of receiving and storing in the computer storage medium information regarding confirmation that the application(s) has been filed, and preventing the computer-related aspects of the presentation (e.g., but not limited to the printing/displaying of components of the presentation) until such confirmation is received. In certain aspects, the computer apparatus is used to apply for the protection of the intellectual property has a computer-readable medium with computer-executable instructions for performing steps including: receiving and storing information for preparing at least one of the applications, preparing at least one of the applications, and transmitting at least one of the applications to at least one selected government agency for filing. Optionally, the computer-executable instructions are also for performing the steps of receiving and storing in the computer storage medium information regarding confirmation that said at least one of the applications has been filed, and preventing printing/display of printable and/or displayable components of the presentation until such confirmation is received.

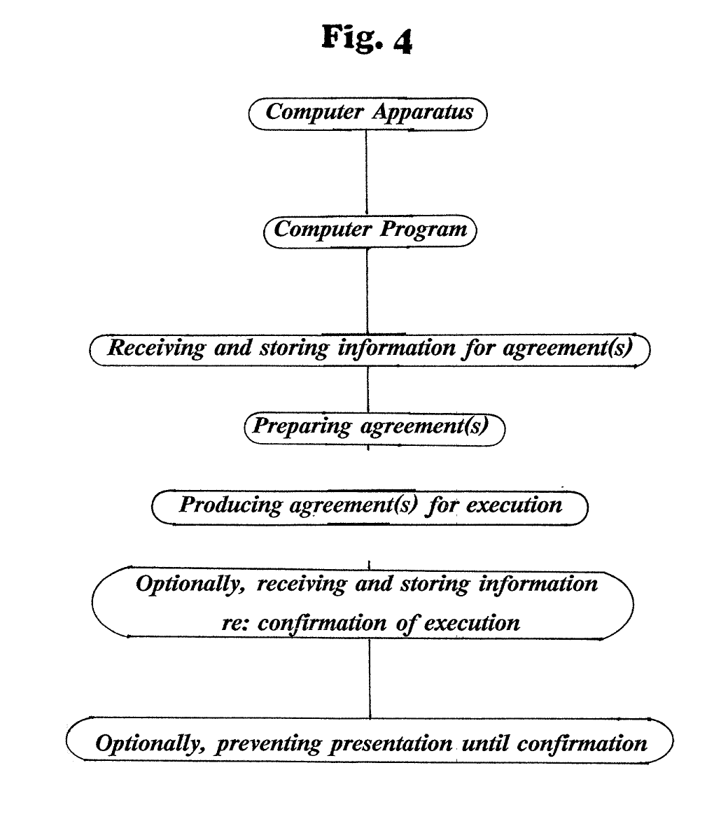

As shown schematically in FIG. 4, a computer apparatus is used according to the present invention on-site to prepare and produce confidentiality agreements for the protection of confidential information of the problem solver and/or its intellectual property. The computer apparatus may be connected to a wireless communication system (e.g., cell phone, Internet and/or satellite system) for wirelessly communicating with appropriate off-site offices and personnel either of the problem solver or of the entity having the problem. In certain aspects, the computer apparatus (one or two or more connected and/or networked computers) is programmed with a computer program product that includes a computer storage medium having a computer program therein for preparing and producing the agreements, the computer program performing the steps of: receiving and storing in the computer storage medium information for preparing the agreement(s); preparing the agreement(s), and producing the agreements, e.g. on-screen and/or in printed versions. Optionally, the computer program is also for performing the steps of receiving and storing in the computer storage medium information regarding confirmation that the agreement(s) has been executed, and preventing the computer-related aspects of the presentation (e.g., but not limited to the printing/displaying of components of the presentation) until such confirmation is received. In certain aspects, the computer apparatus used for the agreements has a computer-readable medium with computer-executable instructions for performing steps including: receiving and storing information for preparing at least one of the agreements, preparing at least one of the agreements, and producing it. Optionally, the computer-executable instructions are also for steps of receiving and storing in the storage medium information for confirmation that the agreement(s) has been executed, and preventing printing/display of components of the presentation until such confirmation is received.

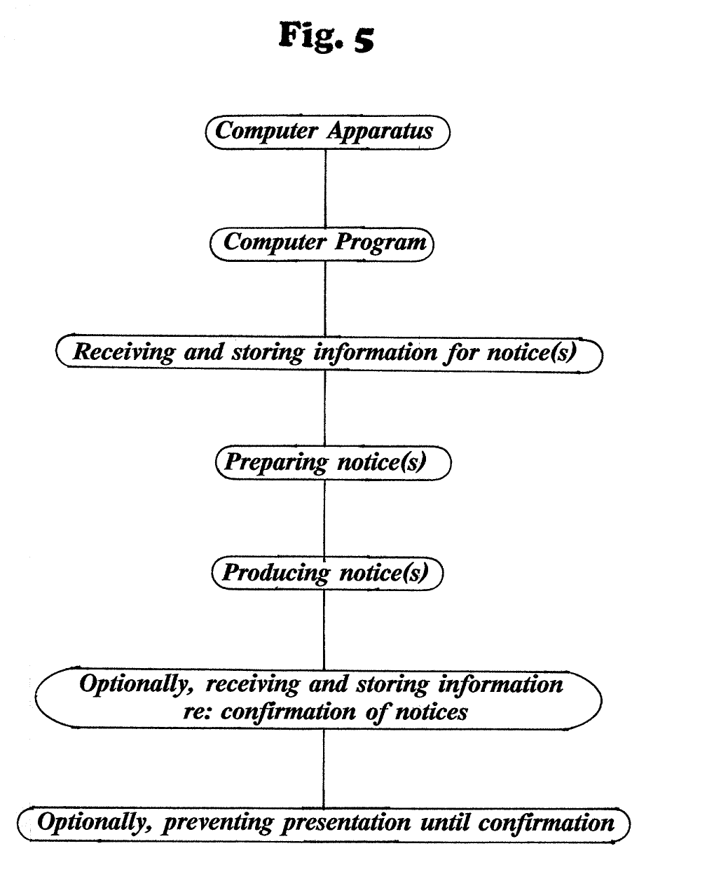

As shown schematically in FIG. 5, a computer apparatus according to the present invention is on-site to prepare and produce notices for the protection of confidential information and of copyrights of the problem solver and/or its intellectual property. The computer appratus may be connected to a wireless commuication system (e.g., cell phone, Internet and/or satellite system) for wirelessly communicating with appropriate off-site offices and personnel either of the problem solver or of the entity having the problem. In certain aspects, the computer apparatus (one or two or more connected and/or networked computers) is programmed with a computer program product that includes a computer storage medium having a computer program therein for preparing and producing the notices, the computer program performing the steps of: receiving and storing in the computer storage medium information for preparing the notice(s); preparing the notice(s), and producing the notice(s), e.g. on documents and drawings, etc.; on-screen and/or in printed versions. Optionally, the computer program is also for performing the steps of receiving and storing in the computer storage medium information regarding confirmation that the notice(s) have been produced and/or applied appropriately, and preventing the computer-related aspects of the presentation (e.g., but not limited to the printing/displaying of components of the presentation) until such confirmation is received. In certain aspects, the computer apparatus used for the agreements has a computer-readable medium with computer-executable instructions for performing steps including: receiving and storing information for preparing at least one of the notices, preparing at least one of the notices, and producing it. Optionally, the computer-executable instructions are also for performing the steps of receiving and storing in the computer storage medium information regarding confirmation that the notice(s) have been produced and/or applied appropriately, and preventing printing/display of printable and/or displayable components of the presentation until such confirmation is received.

The present invention, therefore, provides in certain, but not necessarily all embodiments, a method for producing a problem solution for an entity having a problem, the method for producing the problem solution on-site at a location at which the problem is experienced, the method including the entity having the problem requesting a problem solver to address the problem, and the entity describing the problem to the problem solver, the problem solver assembling a team for solving the problem and dispatching the team on-site to the location at which the problem is experienced, the team including personnel necessary to solve the problem and to produce a presentation of a problem solution for the entity having the problem, the team gathering information related to the problem, the team on-site creating a proposed solution to the problem and producing an on-site presentation of the proposed solution to the entity having the problem, the team presenting the presentation onsite to the entity having the problem (and/or off-site via suitable communications systems), and the presentation including technical information related to the proposed solution, visual images of components of the proposed solution, and visual images of steps in an implementation of the proposed solution. Such a method may include one or some of the following, in any possible combination: wherein the problem is an equipment problem, and the location is a drilling rig; wherein the team includes members who are engineers, scientists, designers, computer programmers, technical writers, technicians, surveyors, patent application professionals, patent agents, patent attorneys, trademark attorneys, copyright attorneys, paralegals and/or intellectual property professionals; wherein the team uses equipment including computers, wireless communication systems, computer programs, printers, audio-visual and audio production and playback apparatus, photographic equipment, drafting equipment and instruments, measuring devices, testing devices, and/or on-site and/or off-site databases; wherein the problem is an equipment problem and the problem is from the group including piping problems, pump problems, solids treatment problems, solids removal problems, equipment selection problems, equipment location problems, fluid flow problems, solids transport problems, equipment transport problems, fluids processing problems, solids processing problems, and/or intellectual property protection problems; wherein the problem is an equipment problem at the drilling rig and the problem is from the group including piping problems, pump problems, solids treatment problems, solids removal problems, equipment selection problems, equipment location problems, fluid flow problems, solids transport problems, equipment transport problems, fluids processing problems, solids processing problems, and/or intellectual property protection problems; displaying parts of a proposed solution in the form text (on screen and/or printed), charts, graphs, photographs, videos, two-dimensional images, three-dimensional images, drawings, slides, and audio information; applying from the on-site location for protection of intellectual property related to the proposed solution and/or sending required information off-site to an intermediate site for such application to be effected and finalized from the intermediate off-site location; effecting application of the protection prior to making the presentation to the entity having the problem wherein the intellectual property is includes inventions, patentable subject matter, trademarks, and copyrights; producing on-site a confidentiality agreement covering part or all of the contents of the presentation for execution by the entity having the problem; wherein apparatus used for the presentation is prevented from operating to present the presentation until said apparatus is inputted with information that the confidentiality agreement has been executed; producing notices for parts of the presentation providing notification of rights in intellectual property; wherein the notices are from the group consisting of confidentiality notices and copyright notices; producing on-site at least one physical model related to a physical embodiment of a component of the proposed solution; producing on-site at least one part of equipment for use in the proposed solution; using a wireless communication system, transmitting the proposed solution off-site to personnel of the entity having the problem using a wireless communication system; wherein the information gathered by the team is from the group includes drawings of the rig, drawings of equipment, specifications of equipment, past problem histories, past problem solutions, log data, photographs, reports, databases, past surveys, and other proposed solutions; conducting engineering work on-site to assist in producing the proposed solution; wherein the team gathers information on-site from off-site sources using a wireless communication system; wherein computer apparatus is used to apply for the protection of the intellectual property, the computer apparatus for wirelessly communicating with appropriate government agencies to effect application for the protection;

wherein the computer apparatus is programmed with a computer program product with a computer storage medium having a computer program therein for preparing and transmitting applications for protection of intellectual property, the computer program performing the steps of receiving and storing in the computer storage medium information for preparing the applications, preparing the applications, and transmitting at least one of the applications to at least one selected government agency; wherein computer apparatus is used to apply for the protection of the intellectual property, the computer apparatus with a computer-readable medium with computer-executable instructions for performing steps including receiving and storing information for preparing at least one of the applications, preparing at least one of the applications, and transmitting at least one of the applications to at least one selected government agency; wherein computer apparatus is used to produce the confidentiality agreement; wherein the computer apparatus is programmed with a computer program product including a computer storage medium having a computer program therein for producing the confidentiality agreement, the computer program performing the steps of receiving and storing in the computer storage medium information for producing the confidentiality agreement, and preparing the confidentiality agreement; wherein computer apparatus is used to produce the confidentiality agreement, the computer apparatus with a computer-readable medium with computer-executable instructions for performing steps including receiving and storing information for producing the confidentiality agreement, and producing the confidentiality agreement; wherein computer apparatus is used to produce the notices; wherein the computer apparatus is programmed with a computer program product including a computer storage medium having a computer program therein for producing the notices, the computer program performing the steps of receiving and storing in the computer storage medium information for producing the notices, and producing the notices; and/or wherein computer apparatus is used to produce the notices, the computer apparatus with a computer-readable medium with computer-executable instructions for performing steps including receiving and storing information for producing at least one of the notices, and producing the notices; and/or wherein any such computer product and/or program includes the step of and/or programming for preventing a presentation until such agreement(s), notice(s) and/or application(s) are executed and/or filed and the computer is informed that such has occurred.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventor may rely on the Doctrine of Equivalents to determine and assess the scope of their invention and of the claims that follow as they may pertain to apparatus not materially departing from, but outside of, the literal scope of the invention as set forth in the following claims.

What is claimed is:

1. A method for producing a problem solution for an entity having a problem, the method for producing the problem solution on-site at a location at which the problem is experienced, the method comprising
the entity having the problem requesting a problem solver to address the problem, and the entity describing the problem to the problem solver,
the problem solver assembling a team for solving the problem and dispatching the team on-site to the location at which the problem is experienced,
the team including personnel necessary to solve the problem and to produce a presentation of a problem solution for the entity having the problem,
the team gathering information related to the problem,
the team on-site making a proposed solution to the problem and producing an on-site presentation of the proposed solution to the entity having the problem,
the team presenting the presentation on-site to the entity having the problem, and
the presentation including technical information related to the proposed solution, visual images of components of the proposed solution, and visual images of steps in an implementation of the proposed solution.

2. The method of claim 1 wherein
the problem is an equipment problem, and
the location is a drilling rig.

3. The method of claim 1 wherein the team includes members from the group consisting of engineers, scientists, designers, computer programmers, technical writers, technicians, surveyors, patent application professionals, and intellectual property professionals.

4. The method of claim 1 wherein the team uses equipment from the group consisting of computers, wireless communication systems, computer programs, printers, audio-visual and audio production and playback apparatus, photographic equipment, drafting equipment and instruments, measuring devices, testing devices, and databases.

5. The method of claim 1 wherein the problem is an equipment problem and the problem is from the group consisting of piping problems, pump problems, solids treatment problems, solids removal problems, equipment selection problems, equipment location problems, fluid flow problems, solids transport problems, equipment transport problems, fluids processing problems, solids processing problems, and intellectual property protection problems.

6. The method of claim 2 wherein the problem is an equipment problem at the drilling rig and the problem is from the group consisting of piping problems, pump problems, solids treatment problems, solids removal problems, equipment selection problems, equipment location problems, fluid flow problems, solids transport problems, equipment transport problems, fluids processing problems, solids processing problems, and intellectual property protection problems.

7. The method of claim 1 further comprising
displaying parts of a proposed solution in a form from the group consisting of text, charts, graphs, photographs, videos, two-dimensional images, three-dimensional images, drawings, slides, and audio information.

8. The method of claim 1 further comprising
applying from the on-site location for protection of intellectual property related to the proposed solution.

9. The method of claim 8 further comprising
effecting application of said protection prior to making the presentation to the entity having the problem.

10. The method of claim 8 wherein the intellectual property is from the group consisting of patents, trademarks, and copyrights.

11. The method of claim 1 further comprising
producing on-site a confidentiality agreement covering contents of the presentation for execution by the entity having the problem.

12. The method of claim 11 wherein apparatus used for the presentation is prevented from operating to present the presentation until said apparatus is inputted with information that the confidentiality agreement has been executed.

13. The method of claim 1 further comprising
producing notices for parts of the presentation providing notification of rights in intellectual property.

14. The method of claim 13 wherein said notices are from the group consisting of confidentiality notices and copyright notices.

15. The method of claim 1 further comprising
producing on-site at least one physical model related to a physical embodiment of a component of the proposed solution.

16. The method of claim 1 further comprising
producing on-site at least one part of equipment for use in the proposed solution.

17. The method of claim 1 further comprising
transmitting the proposed solution off-site to personnel of the entity having the problem using a wireless communication system.

18. The method of claim 2 wherein the information gathered by the team is from the group consisting of drawings of the rig, drawings of equipment, specifications of equipment, past problem histories, past problem solutions, log data, photographs, reports, databases, past surveys, and other proposed solutions.

19. The method of claim 1 further comprising
conducting engineering work on-site to assist in producing the proposed solution.

20. The method of claim 1 wherein the team gathers information on-site from off-site sources using a wireless communication system.

21. The method of claim 8 wherein computer apparatus is used to apply for the protection of the intellectual property, said computer apparatus for wirelessly communicating with appropriate government agencies to effect application for said protection.

22. The method of claim 21 wherein said computer apparatus is programmed with a computer program product comprising a computer storage medium having a computer program therein for preparing and transmitting applications for protection of intellectual property, said computer program performing the steps of
receiving and storing in said computer storage medium information for preparing said applications,
preparing said applications, and
transmitting at least one of said applications to at least one selected government agency for filing.

23. The method of claim 22 wherein said computer program is also for performing the steps of
receiving and storing in said computer storage medium information regarding confirmation that said at least one of said applications has been filed, and
preventing display of displayable components of said presentation until such confirmation is received.

24. The method of claim 8 wherein computer apparatus is used to apply for the protection of the intellectual property, said computer apparatus with a computer-readable medium with computer-executable instructions for performing steps comprising
receiving and storing information for preparing at least one of said applications,
preparing at least one of said applications, and
transmitting at least one of said applications to at least one selected government agency for filing.

25. The method of claim 24 wherein said computer-executable instructions are also for performing the steps of
receiving and storing in said computer storage medium information regarding confirmation that said at least one of said applications has been filed, and
preventing display of displayable components of said presentation until such confirmation is received.

26. The method of claim 11 wherein computer apparatus is used to produce the confidentiality agreement.

27. The method of claim 26 wherein said computer apparatus is programmed with a computer program product comprising a computer storage medium having a computer program therein for producing the confidentiality agreement, said computer program performing the steps of
receiving and storing in said computer storage medium information for producing said confidentiality agreement, and
preparing said confidentiality agreement.

28. The method of claim 27 wherein said computer program is also for performing the steps of
receiving and storing in said computer storage medium information regarding confirmation that said confidentiality agreement has been executed, and
preventing display of displayable components of said presentation until such confirmation is received.

29. The method of claim 11 wherein computer apparatus is used to produce the confidentiality agreement, said computer apparatus with a computer-readable medium with computer-executable instructions for performing steps comprising
receiving and storing information for producing said confidentiality agreement, and
producing said confidentiality agreement.

30. The method of claim 29 wherein said computer-executable instructions are also for performing the steps of
receiving and storing in said computer storage medium information regarding confirmation that said confidentiality agreement has been executed, and
preventing display of displayable components of said presentation until such confirmation is received.

31. The method of claim 13 wherein computer apparatus is used to produce said notices.

32. The method of claim 31 wherein said computer apparatus is programmed with a computer program product comprising a computer storage medium having a computer program therein for producing said notices, said computer program performing the steps of
receiving and storing in said computer storage medium information for producing said notices, and
producing said notices.

33. The method of claim 32 wherein said computer program is also for performing the steps of
receiving and storing in said computer storage medium information regarding confirmation that said notices have been applied to parts of the presentation, and
preventing display of displayable components of said presentation until such confirmation is received.

34. The method of claim 13 wherein computer apparatus is used to produce said notices, said computer apparatus with a computer-readable medium with computer-executable instructions for performing steps comprising
receiving and storing information for producing at least one of said notices, and
producing said notices.
transmitting at least one of said applications to at least one selected government agency.

35. The method of claim 34 wherein said computer-executable instructions are also for performing the steps of
receiving and storing in said computer storage medium information regarding confirmation that said notices have been produced, and
preventing display of displayable components of said presentation until such confirmation is received.
